(19) United States
(12) Patent Application Publication
(10) Pub. No.: US 2011/0044491 A1
(43) Pub. Date: Feb. 24, 2011

(54) LONG EXCURSION LOUDSPEAKER WITH CLOSED MAGNETIC CIRCUIT AND RIBBED ROBBIN EXTENDING THROUGH SLOTTED YOKE

(75) Inventors: Edward Ku, Yuen Long (HK); Richard Louis Weisman, Pasadena, CA (US); Chun Hua Li, Jiangxi (CN)

Correspondence Address: PLASTOFORM INDUSTRIES LTD., UNITS 6A-12, 15/F., MITA CENTRE, 552-566 CASTLE PEAK ROAD., KWAI CHUNG, N.T., HK

(73) Assignee: Plastoform Industries Ltd., New Territories (HK)

(21) Appl. No.: 12/545,857

(22) Filed: Aug. 23, 2009

(51) Int. Cl. H04R 1/00

(52) U.S. Cl. 381/433

(57) ABSTRACT

An audio loudspeaker with an internal magnet geometry motor having a slotted cylinder having closed ends, a pair of oppositely charged magnets sandwiching a top plate and disposed between the closed ends of the cylinder, and a diaphragm assembly having a bobbin with spokes which extend through the slots. Mechanically connecting to the voice coil radially through the cylinder enables the lower suspension component to be places much lower and farther from the upper suspension component, improving stability of the suspension. The closed ends of the motor provide extremely low magnetic reluctance for the magnetic circuits at the respective ends of the motor.

### BACKGROUND OF THE INVENTION

This invention relates generally to electromagnetic transducers, and more specifically to magnetic circuit and bobbins and cup yokes for such, and yet more specifically to a loudspeaker having a closed low reluctance magnetic circuit and a slotted cup yoke and a ribbed bobbin or voice coil former which extends through the slots of the motor to connect a portion carrying the voice coil inside the motor to a portion coupling to the lower suspension component outside the motor.

Electromagnetic transducers, such as audio loudspeakers, are known to use a variety of motor geometries. The most common is the external magnet motor, in which an annular magnet and an annular top plate are used with a pole plate style yoke, Another is the internal magnet motor, in which a disc magnet and a disc top plate are used with a cup style yoke. In either configuration, one challenge for the engineer is to create a design which has both tight tolerances of the components in the magnetic air gap (to reduce reluctance of the magnetic circuit and thereby increase sensitivity) and a suspension system which is both compliant in the axial direction and yet is adequate to keep the various components in correct alignment (to prevent rubbing and thereby reduce distortion and wear) throughout the movement of the voice coil.

Most transducers, especially larger ones, use an upper suspension component (a surround) as well as a lower suspension component (either a damper or a spider), coupled respectively at the top of the bobbin and in the middle of the bobbin above the magnet assembly. The greater the axial distance between them, the better alignment they provide.

Unfortunately, conventional motors use solid, uninterrupted magnets, top plates, and yokes. As a result, the lower suspension component must generally be coupled to the bobbin (or even to the diaphragm) at a point above the uppermost outer motor component (the cup yoke in an internal magnet motor, or the top plate in an external magnet motor) plus the maximum inward travel of the bobbin plus some safety margin, to prevent the lower suspension component from striking the motor. This places the lower suspension component significantly above the voice coil, reducing its ability to control rocking and lateral movement of the voice coil.

The inventor's U.S. Pat. No. 6,865,282 “Loudspeaker Suspension for Achieving Very Long Excursion” discloses a loudspeaker having an internal magnet geometry motor with a slotted cup, permitting the use of a “spring spider” lower suspension component which, because of the slots in the cup yoke, can be coupled to the bobbin below the voice coil.

The present invention is a significant improvement on that principle, and offers both an improved suspension and an improved efficiency magnet assembly.

### BRIEF SUMMARY OF THE INVENTION

To attain this, the present invention generally comprises an internal magnet geometry motor and a bobbin. The motor includes a ventilated, capped cylinder yoke, a first magnet, a second magnet and a top plate assembly. The yoke has a cylindrical portion having a plurality of slots extending radially outward through the cylindrical portion, a first cap portion magnetically coupled to a first end of the cylindrical portion, and a second cap portion magnetically coupled to a second end of the cylindrical portion. The first magnet is coupled inside the first cap portion and has a first, substantially axial magnetic polarization. The second magnet is coupled inside the second cap portion and has a second magnetic polarization substantially opposite the first polarization. The top plate assembly is magnetically coupled between the first and second magnets and forms a magnetic air gap with the cylindrical portion. The bobbin is coupled to a lower portion of a diaphragm and has a body disposed around the motor, a carrier portion disposed within the magnetic air gap and coupled to a voice coil, and a plurality of ribs extending radially through respective ones of the slots and coupling the body to the carrier portion.

The present invention further comprises a frame, an upper suspension component coupling an upper portion of the diaphragm to the frame, and a lower suspension component coupling a lower portion of the body of the bobbin to the frame. The lower suspension component comprises a lower surround or a damper with fully circumferential geometry. The upper suspension component comprises an upper surround with fully circumferential geometry. In a preferred embodiment, the upper suspension component and the lower suspension component each has a roll disposed around its periphery and the rolls of the upper and lower suspension components extend in opposite axial directions.

In one embodiment, the cylindrical portion couples to the first cap portion and form a slotted cup. The slotted cup is disposed at a bottom of the motor. In another embodiment, the ventilated, capped cylinder yoke comprises a pair of slotted cups coupled together at ends of their cylindrical portions. The slotted cups mate with each other with an inner feature and an outer feature, whereby the slotted cups remain in magnetic coupling notwithstanding any tolerance gap caused by a stackup dimension of the magnets and the top plate between the slotted cups. In yet another embodiment, each slotted cup includes a first plurality of cylinder segments having the inner feature and a second plurality of cylinder segments having the outer feature.

In a preferred embodiment, the top plate assembly comprises an inner cup; and a top plate magnetically coupled to a top of the inner cup. In another embodiment, the top plate assembly is in form of a solid top plate.

In one embodiment, the diaphragm and the upper suspension component are of monolithic construction. In another embodiment, the diaphragm and the upper suspension component are separate components coupled together.

The present invention may further comprises lead wires coupled to the voice coil and extending out through one or more of the slots and extend over the lower suspension component to one or more electrical connectors which are coupled to the frame so as to provide electrical connection to the voice coil. Further, the first cap portion, the second cap portion, the first magnet, the second magnet and the top plate assembly are formed to have an axial vent extending therethrough.

In one embodiment, the first magnet and the second magnet are each in form of a hybrid magnet which comprises a neodymium-ferrite-boron magnet and a ferrite magnet.

### BRIEF DESCRIPTION OF THE DRAWINGS

FIGS. 1 and 2 show a loudspeaker according to one embodiment of this invention, in cross section view and exploded view, respectively, demonstrating the motor components including the slotted cup yoke, the unconventional bobbin, and the damper.

FIG. 3 shows a bobbin such as used in the loudspeaker of FIG. 1.

FIG. 4 shows another bobbin that may be used in practicing this invention.

FIG. 5 shows yet another bobbin that may be used in practicing this invention.

FIGS. 6A and 6B show, in exploded view and sectional view, respectively, another embodiment of a magnet assembly that may be used in practicing this invention.

FIGS. 7A and 7B show, in perspective view and exploded view, respectively, another embodiment of a motor that may be used in practicing this invention.

FIGS. 8A and 8B show, in cross section view, yet another motor that may be used in practicing this invention.

FIG. 9 shows, in exploded view, another motor that may be used in practicing this invention.

FIGS. 10A and 10B show, in exploded view and in sectional view, respectively, another motor that may be used in practicing this invention.

### DETAILED DESCRIPTION OF THE INVENTION

The invention will be understood more fully from the detailed description given below and from the accompanying drawings of embodiments of the invention which, however, should not be taken to limit the invention to the specific embodiments described, but are for explanation and understanding only.

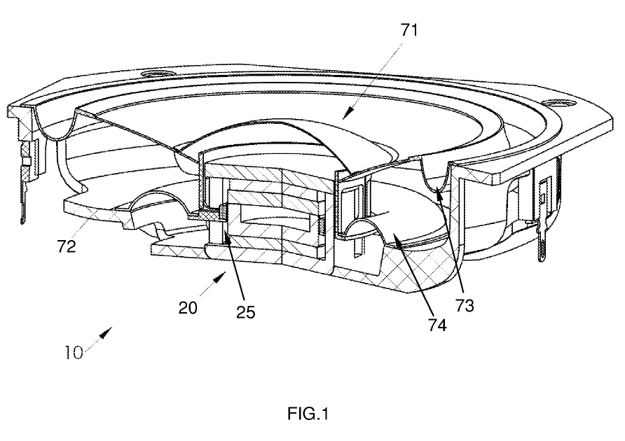

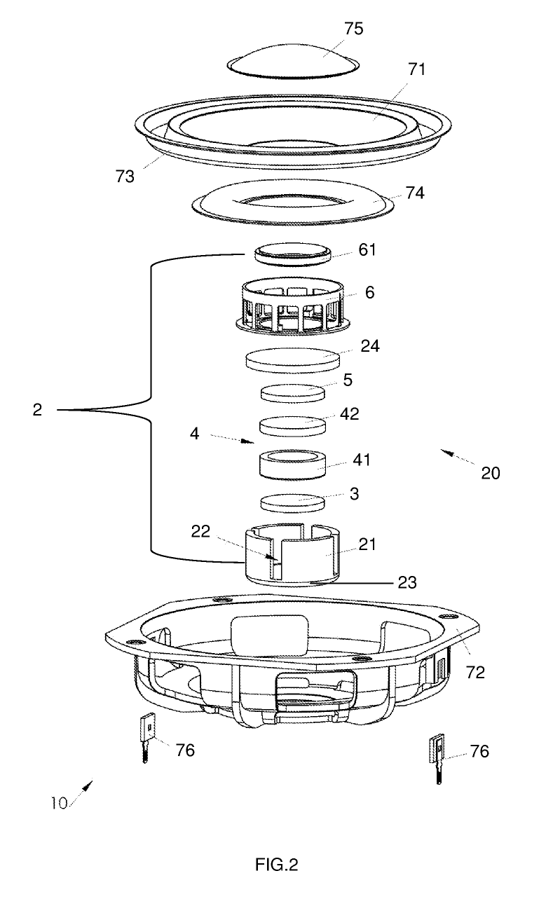

FIGS. 1 and 2 illustrate a loudspeaker 10 according to one embodiment of this invention, in cross sectioned perspective view and in exploded view, respectively. The loudspeaker includes an internal magnet geometry motor 20 coupled to a diaphragm assembly 71 by a frame 72 and suspension components 73, 74.

The motor includes a yoke 2 having a cylindrical portion 21 having a plurality of slots 22 extending radially outward through the cylindrical portion 21, a first cap portion 23 magnetically coupled to a first end of the cylindrical portion 21, and a second cap portion 24 magnetically coupled to a second end of the cylindrical portion 21. In this embodiment, the first cap portion 23 takes the form of a back plate integrally formed at the bottom end of the cylindrical portion 21 so that the back plate and the cylindrical portion 21 together form a slotted cup yoke. The second cap portion 24 takes the form of a cap plate coupled to the top end of the cylindrical portion 21. An axially charged lower permanent magnet 3 is coupled between the first cap portion 23 of the yoke 2 and a top plate assembly 4. The outer surface of the top plate assembly 4 and the inner surface of the cylindrical portion 21 of the yoke 2 define the magnetic air gap 25 of the motor 20. An axially charged upper permanent magnet 5 is polarized opposite the lower magnet 3, and is coupled between the top plate assembly 4 and the second cap portion 24.

In the embodiment shown, the top plate assembly 4 includes an inner cup 41 and a top plate 42. The void or hollow inside the inner cup 41 reduces the weight of the motor 20. In another embodiment, a simple, solid top plate could be used.

Magnetic flux from the lower magnet 3 flows upward into the top plate assembly 4, thence outward over the magnetic air gap 25 into the cylindrical portion 21 of the yoke 2, down through the cylindrical portion 21, and back to the lower magnet 3 via the first cap portion 23 of the yoke 2. Similarly, magnetic flux from the upper magnet 5 flows downward into the top plate assembly 4, outward over the magnetic air gap 25 into the cylindrical portion 21 of the yoke 2, up through the cylindrical portion 21, and back to the upper magnet 5 via the second cap portion 24. These two magnetic circuits have very low magnetic reluctance, because the only portion of them that is not either magnetically permeable material such as steel (the yoke and plates) or actual magnet, is the narrow magnetic air gap 25.

In a conventional loudspeaker, such a second cap portion 24 could not be employed, because the cylindrical bobbin 6 must extend axially out of the motor 20 from the magnetic air gap 25 to couple with the diaphragm 71. However, in the present invention, the diaphragm 71 is coupled outside of the magnet assembly and so permits the use of the second cap portion 24 which closes the magnetic circuit thereby significantly reducing the reluctance of the motor 20.

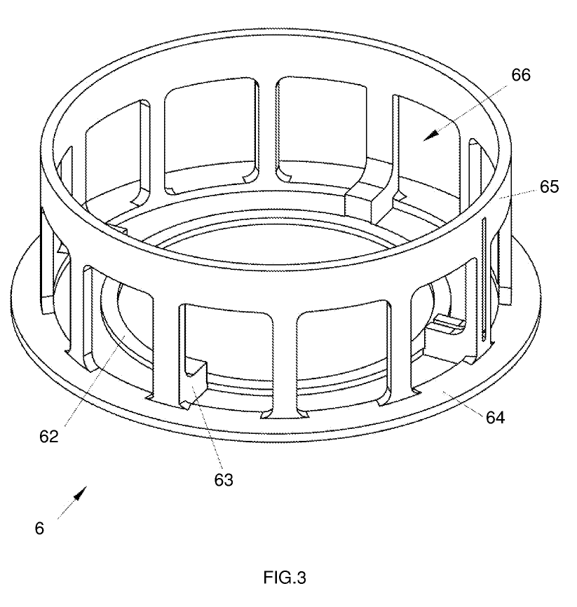

FIG. 3 should also be referenced, briefly, along with FIGS. 1 and 2. The voice coil 61 is disposed in the magnetic air gap 25 and is coupled to a carrier portion 62 of the bobbin 6. The bobbin 6 includes ribs 63 which are coupled to the carrier portion 62 and which extend through the slots 22 of the yoke 2. The bobbin 6 further includes a damper connection portion 64, advantageously located at a lower end of the bobbin 6, and a diaphragm connection portion 65, advantageously located at an upper end of the bobbin 6. The bobbin 6 may optionally be provided with a plurality of ventilation holes 66 which improve air flow in and out of the motor 20, thereby improving cooling of the motor 20, which reduces heat related problems such as thermal compression, glue delamination, and the like.

A lower suspension component 74 such as a damper is coupled to the frame 72 and to the damper connection portion 64 of the bobbin 6. Loudspeaker suspensions ideally should be as compliant in the axial direction as possible but, at the same time stiff in the radial direction to keep the moving components from crashing into or rubbing against the magnetic assembly. The Axial to Radial Compliance (ARC) ratio is a figure of merit for this attribute. A higher ARC ratio makes possible greater sound pressure level output at low frequencies before rubbing. In contrast to the spring spider employed in U.S. Pat. No. 6,865,282, the present invention employs a more conventional damper/spider with fully circumferential geometry. Fully circumferential loudspeakers have the advantage of a higher ARC ratio compared with the cantilever spring spiders.

A diaphragm 71 is coupled to the diaphragm connection portion 65 of the bobbin 6, and is sealed by an integral or separate dust cap 75. An upper suspension component 73 such as a surround couples the diaphragm 71 to the frame 72. In the present embodiment, the upper suspension component 73 and the diaphragm 71 are of monolithic construction, but in other embodiments they may be separate components coupled together. In the present embodiment, the upper and lower suspension components 73, 74 are oriented with their rolls in opposite directions, as shown, to reduce the overall height of the loudspeaker and to improve the symmetry of the overall suspension forces in inbound versus outbound motion of the diaphragm assembly.

A pair of electrical connectors or terminals 76 are coupled to the frame and 72 provide electrical connection to the voice coil 61 via lead wires (not shown) which may advantageously extend over the lower suspension component 74 and through the slots 22 of the yoke 2.

The use of the slotted yoke 2 enables the lower suspension component 74 to be coupled significantly lower than the spider of a conventional loudspeaker, even below the voice coil 61. The use of the slotted yoke 2 also enables the motor 20 to use a cap plate 24, which enables the motor 20 to effectively utilize a greatly increased percentage of the magnetic flux available from the upper magnet 5.

The frame 72 may be ventilated behind the diaphragm 71 and behind the lower suspension component 74, as shown in FIG. 2, or it may be unventilated to provide a self enclosed loudspeaker especially in smaller sizes.

In FIGS. 1 and 2, the motor 20 has been shown and described with its slotted cup yoke 2 facing “upward”, that is, with the cup yoke's first cap portion 23 at the bottom of the motor 20. In another embodiment, the motor 20 could actually be inverted, with the cup yoke's first cap portion 23 at the top of the motor 20, the slots 22 extending downward, and the second cap portion 24 at the bottom of the motor 20.

In the embodiment shown, the second cap portion 24 mates with the upper surface of the cylindrical portion 21, but in other embodiments it could mate with the inner surface of a taller cylindrical portion 21. In some such embodiments, it may be press fit, or it may slide in, or it may have a threaded engagement with the cylindrical portion 21.

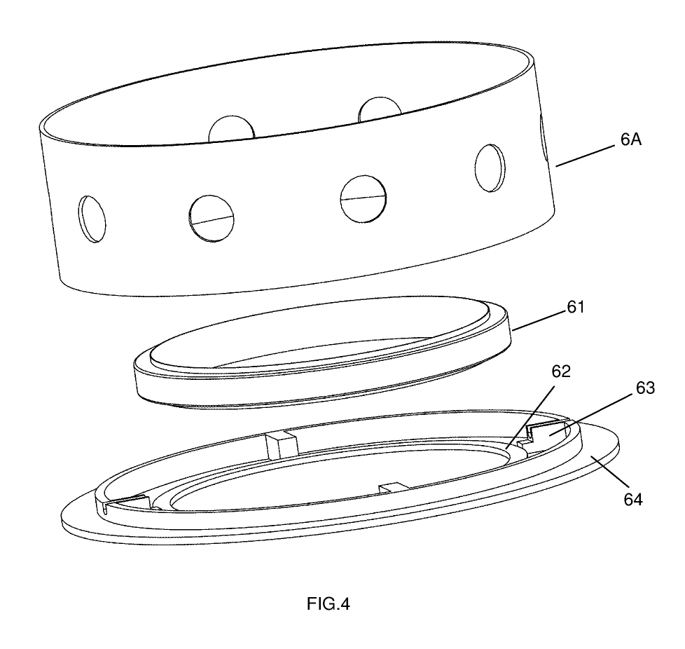

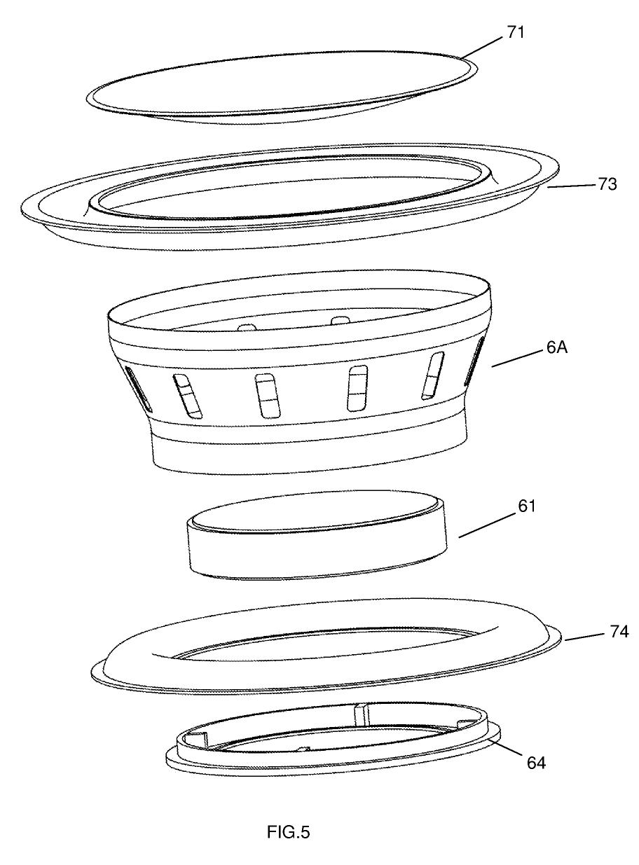

In another embodiment as shown in FIG. 4, the bobbin 6 includes two separate parts coupled together, namely a bobbin body 6A and a damper connection portion 64. The damper connection portion 64 is provided with ribs 63 which extend through the slots 22 of the yoke 2 and couple to a carrier portion 62. In this embodiment, the bobbin body 6A is a cylindrical body having fixed diameter, the top rim of the bobbin body 6A serves as a diaphragm connection portion 65 for coupling to a diaphragm 71. In another embodiment as shown in FIG. 5, the bobbin body 6A is in cone shape with a larger opening at the top and a smaller opening at the bottom, and the top end of the cone is provided with a vertical rim to serve as the diaphragm connection portion 65.

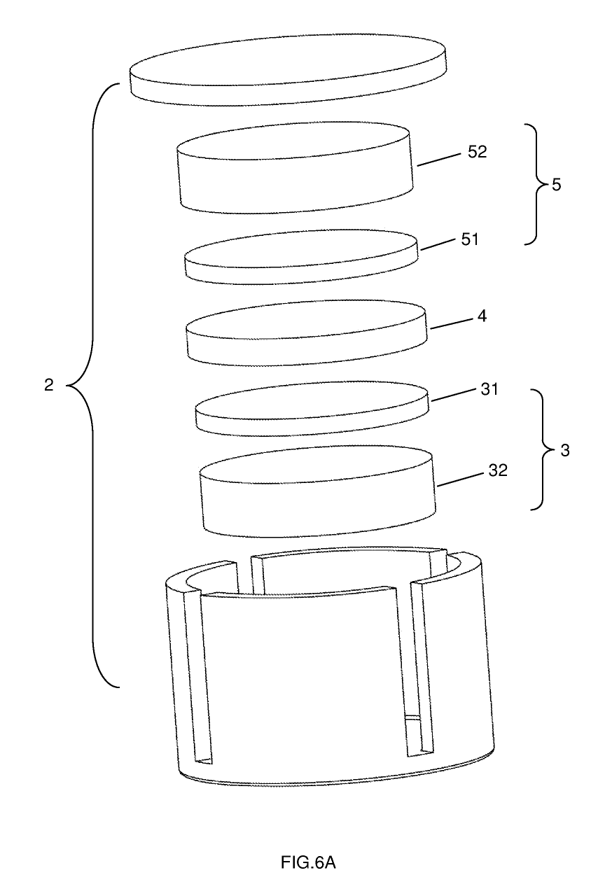

In a preferred embodiment as shown in FIGS. 6A and 6B, the upper magnet 5 and the lower magnet 3 are each in form of a hybrid magnet which comprises a neodymium-ferrite-boron magnet 51, 31 and a ferrite magnet 52, 32. The low magnetic reluctance offered by the use of the slotted yoke 2 allows the use of weaker and less expensive magnets, e.g. the hybrid magnet formed by the less expensive yet weaker ferrite magnet and the more expensive yet stronger neodymium-ferrite-boron magnet in this embodiment, while achieving the same flux density in the magnetic air gap 25. The low magnetic reluctance offered by the slotted yoke 2 also allows the overall height of the motor 20 to be increased at an affordable cost while achieving the same flux density in the magnetic air gap 25. This can be achieved by simply using taller top plate assembly 4 or hybrid magnets, the costs of which are significantly lower. A taller motor provides more space for the movement of the voice coil, thereby increasing the excursion capability of the speaker.

The net result is a loudspeaker having a large excursion capability, robust radial centering to avoid rocking and rubs, a higher efficiency and a very shallow axial dimension.

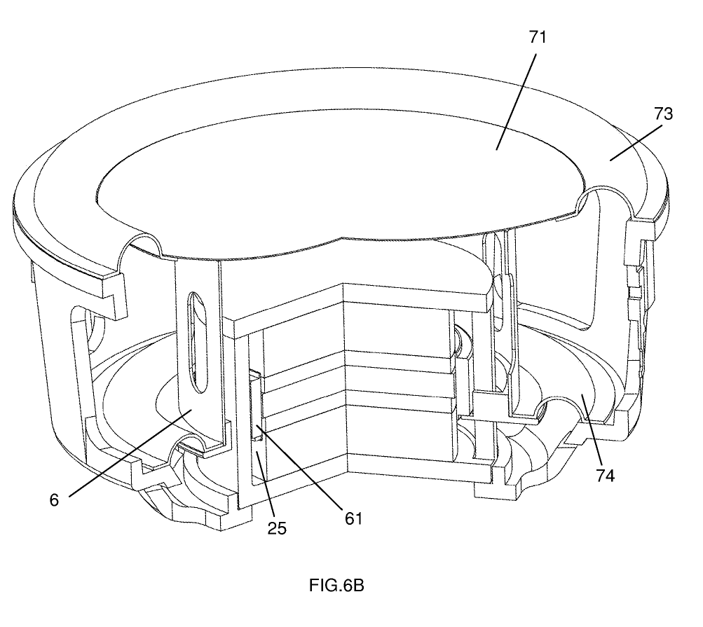

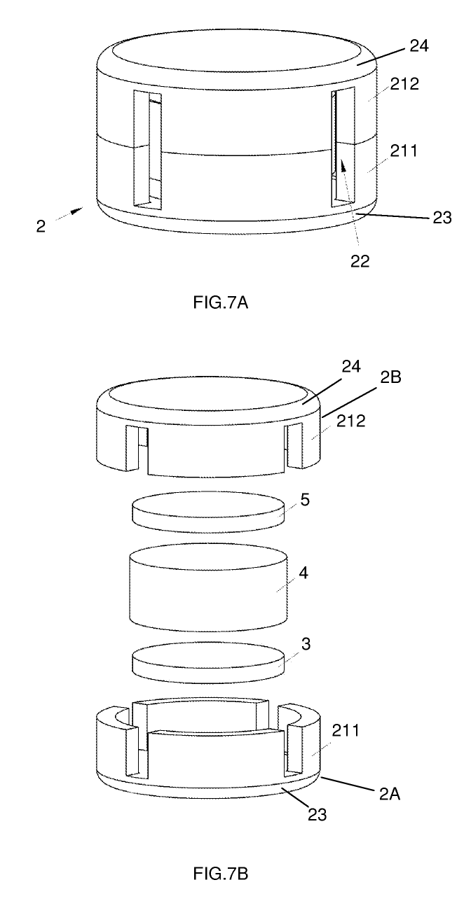

FIGS. 7A and 7B illustrate another embodiment of a loudspeaker motor 20 which may be used in practicing this invention. In this embodiment, the motor includes a yoke 2 having a first cylindrical portion 211 and a second cylindrical portion 212 each with a plurality of slots 22 extending radially outward through the first and second cylindrical portions 211, 212, a first cap portion 23 magnetically coupled to a first end of the first cylindrical portion 211, and a second cap portion 24 magnetically coupled to a second end of the second cylindrical portion 212. In this embodiment, the first cap portion 23 takes the form of a back plate integrally formed at the bottom end of the first cylindrical portion 211 so that the back plate and the first cylindrical portion 211 together form a lower slotted cup yoke 2A. The second cap portion 24 takes the form of a cap plate integrally formed at the top end of the second cylindrical portion 212 so that the cap plate and the second cylindrical portion 212 together form an upper slotted cup yoke 2B. The slots of the lower slotted cup yoke 2A substantially align with those of the upper slotted cup yoke 2B. The motor 20 further includes a lower magnet 3, a top plate 4, and an upper magnet 5 polarized opposite the lower magnet 3. The slots are shared across the two half height slotted cup yokes 2A, 2B, rather than a single full height slotted cup yoke as in FIG. 1. Optionally but advantageously, the two slotted cup yokes 2A, 2B may simply be two units of the same component, and likewise the two magnets 3, 5 may be identical, reducing the parts inventory requirement for the manufacturer.

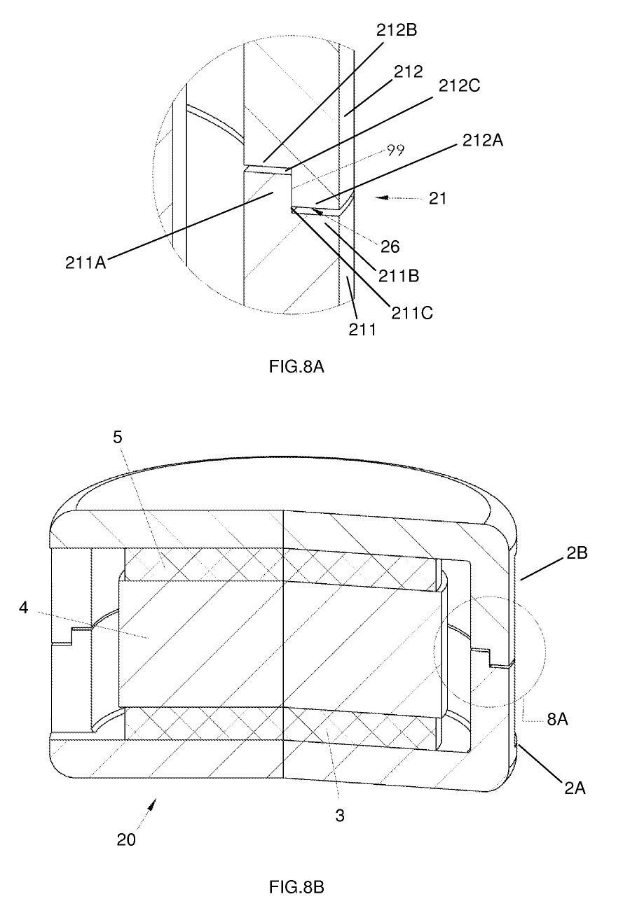

FIGS. 8A and 8B, with a detail view 8A, illustrate yet another motor 20 which may be used in practicing this invention. Similar to the previous embodiment as shown in FIGS. 7A and 7B, the motor includes a lower slotted cup yoke 2A and an upper slotted cup yoke 2B. However, the two slotted cup yokes 2A, 2B do not merely butt end to end, but have a mating feature which provides improved radial alignment and also provides tolerance for variations in the thicknesses of the internal magnets 3, 5 and the top plate 4. If the internal stackup is unexpectedly tall, the two slotted cup yokes 2A, 2B will simply not slide all the way into abutment, leaving a small tolerance gap 26 in the middle portion of the overall cylindrical portion 21. In the embodiment as shown in FIGS. 8 and 8A, the mating feature is achieved by making the lower slotted cup yoke 2A an “inner cup” and the upper slotted cup yoke 2B an “outer cup”. More particularly, the inner cup 2A comprises a taller portion 211A of the cylindrical portion 211 at its inner diameter and a shorter portion 211B of the cylindrical portion 211 at its outer diameter; correspondingly, the outer cup 2B comprises a shorter portion 212B of the cylindrical portion 212 at its inner diameter and a taller portion 212A of the cylindrical portion 212 at its outer diameter. When the inner cup 2A mates with the outer cup 2B, an outer wall 211C of the taller portion 211A of the cylindrical portion 211 of the inner cup 2A which extends beyond the shorter portion 211B of the cylindrical portion 211 of the inner cup 2A couples with an inner wall 212C of the taller portion 212A of the cylindrical portion 212 of the outer cup 2B which extends beyond the shorter portion 212B of the cylindrical portion 212 of the outer cup 2B.

Because this tolerance gap is substantially in the middle of the cylindrical portion (or, more to the point, generally located between the magnetic circuits or at the resting position of the voice coil), it will not materially increase the overall magnetic reluctance of the magnetic circuitry of the motor. Magnetic flux traveling over the magnetic air gap and entering the cylindrical portion above the tolerance gap will generally enter the upper magnetic circuit, and magnetic flux entering the cylindrical portion below the tolerance gap will generally enter the lower magnetic circuit. Unlike a gap at a location closer to either end of the cylindrical portion, a tolerance gap near the middle does not significantly interrupt either magnetic circuit, especially given that the two cup yokes are in direct contact at the interface 99 formed by the outer wall 211C of the taller portion of the cylindrical portion of the inner cup and the inner wall 212C of the taller portion of the cylindrical portion of the outer cup.

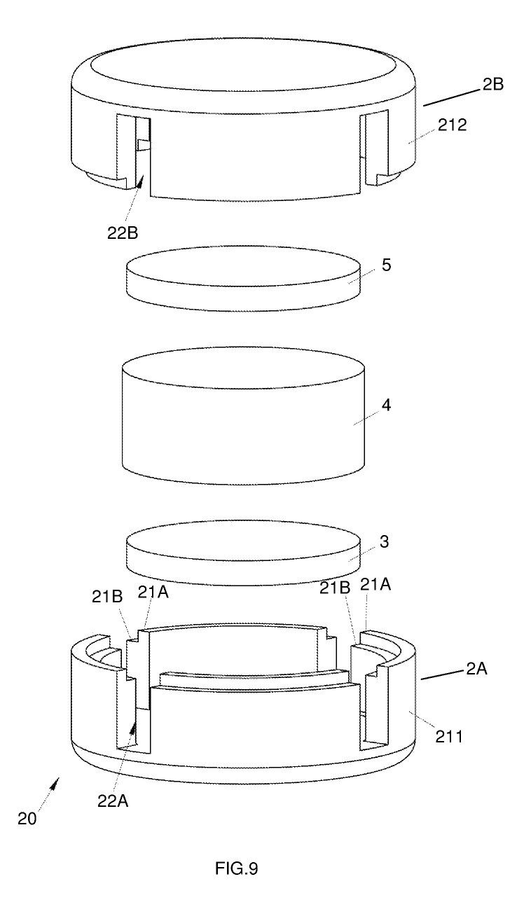

FIG. 9 illustrates another embodiment similar to that as illustrated in FIGS. 8A and SB. In this embodiment, the “inner” and “outer” features are shared by both the upper and lower slotted cup yokes 2A, 2B, which can then be two units of the same component, especially if there are an even number of slots. The motor 20 is shown in exploded view, and includes the lower slotted cup yoke 2A with slots 22A, lower magnet 3, top plate 4, upper magnet 5, and upper slotted cup yoke 2B with slots 22B.

Alternating segments of the cylindrical portion are “inner” segments and “outer segments”. More particularly as shown in the lower slotted cup yoke 2A in FIG. 9, the inner segment has a taller portion 21A of the cylindrical portion 211 at its inner diameter, and a shorter portion 21B of the cylindrical portion 211 at its outer diameter. An outer segment has a shorter portion 21B of the cylindrical portion 211 at its inner diameter, and a taller portion 21A of the cylindrical portion 211 at its outer diameter. By rotating the upper slotted cup yoke 2B into proper alignment with the lower slotted cup yoke 2A, an inner segment of the upper slotted cup yoke 2B will engage an outer segment of the lower slotted cup yoke 2A, and vice versa.

After the motor 20 is assembled, any tolerance gap between the slotted cup yokes can optionally be filled with e.g. an epoxy impregnated with powdered iron, to reduce or eliminate any magnetic circuit effects of the tolerance gap, and also to lock the slotted cup yokes into proper rotational orientation.

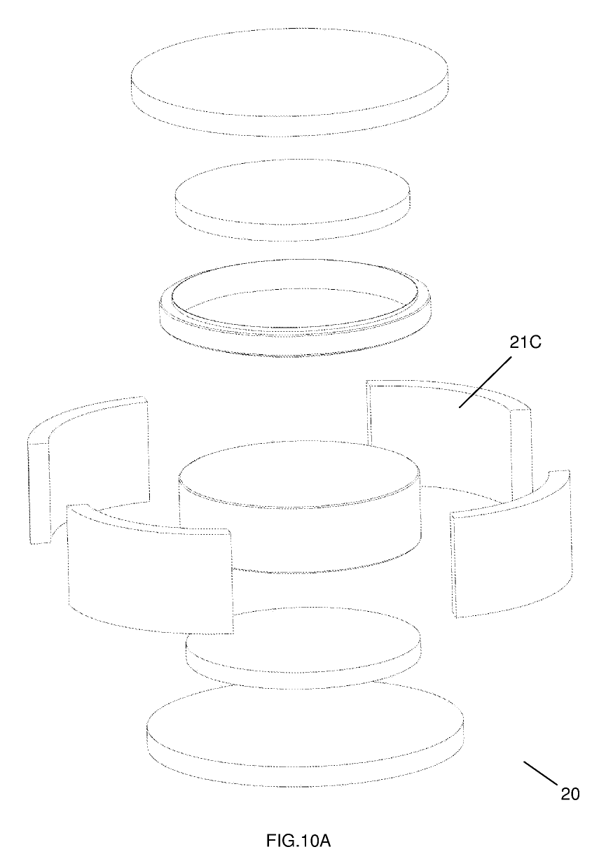

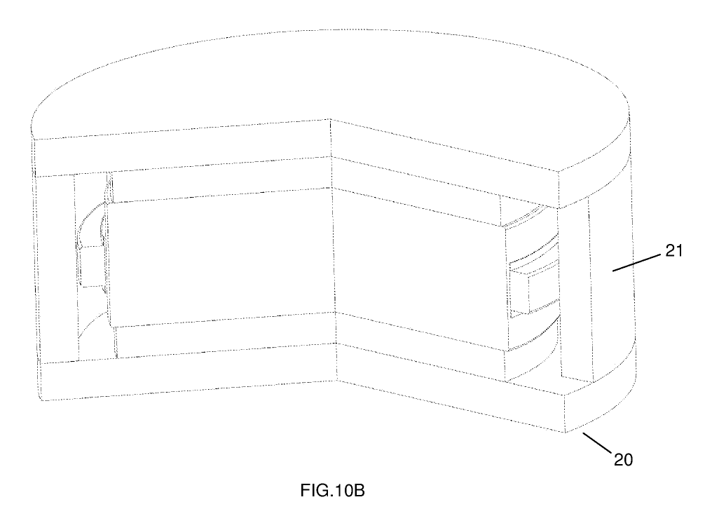

FIGS. 10A and 10B illustrates yet another embodiment of the motor 20 in which the cylindrical portion 21 is formed by a plurality of cylindrical arc segments 21C having spaces forming slots between them.

Regardless of the specific cup, cap plate, etc. components employed, the outer “shell” of the motor may be termed a “ventilated, capped cylinder yoke” in that it has a generally cylindrical portion with capped, closed ends. Both the cup's back plate and the cap plate may be termed “cap portions” of the yoke.

The capped cylinder yoke and its internal magnets and top plate assembly can optionally be formed so as to have an axial vent extending through the motor, to depressurize the bottom surface of the dust cap, and thereby improve performance of the loudspeaker. This will, of course, reduce the amount of magnet surface area available versus a non ventilated configuration, given the same voice coil diameter.

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Those skilled in the art, having the benefit of this disclosure, will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An electromagnetic transducer comprising:
an internal magnet geometry motor including
a ventilated, capped cylinder yoke having,
a cylindrical portion having a plurality of slots extending radially outward through the cylindrical portion,
a first cap portion magnetically coupled to a first end of the cylindrical portion, and
a second cap portion magnetically coupled to a second end of the cylindrical portion,
a first magnet coupled inside the first cap portion and having a first, substantially axial magnetic polarization,
a second magnet coupled inside the second cap portion and having a second magnetic polarization substantially opposite the first polarization, and
a top plate assembly magnetically coupled between the first and second magnets and forming a magnetic air gap with the cylindrical portion; and
a bobbin coupled to a lower portion of a diaphragm and having
a body disposed around the motor,
a carrier portion disposed within the magnetic air gap and coupled to a voice coil, and
a plurality of ribs extending radially through respective ones of the slots and coupling the body to the carrier portion.

2. The electromagnetic transducer of claim 1 wherein it further comprises:
a frame;
an upper suspension component coupling an upper portion of the diaphragm to the frame; and
a lower suspension component coupling a lower portion of the body of the bobbin to the frame.

3. The electromagnetic transducer of claim 2 wherein the lower suspension component comprises a lower surround.

4. The electromagnetic transducer of claim 2 wherein the lower suspension component comprises a damper with fully circumferential geometry.

5. The electromagnetic transducer of claim 2 wherein the upper suspension component comprises an upper surround with fully circumferential geometry.

6. The electromagnetic transducer of claim 2 wherein the upper suspension component and the lower suspension component each has a roll disposed around its periphery and the rolls of the upper and lower suspension components extend in opposite axial directions.

7. The electromagnetic transducer of claim 1 wherein the cylindrical portion couples to the first cap portion and form a slotted cup.

8. The electromagnetic transducer of claim 7 wherein the slotted cup is disposed at a bottom of the motor.

9. The electromagnetic transducer of claim 1 wherein the ventilated, capped cylinder yoke comprises a pair of slotted cups coupled together at ends of their cylindrical portions.

10. The electromagnetic transducer of claim 9 wherein the slotted cups mate with each other with an inner feature and an outer feature, whereby the slotted cups remain in magnetic coupling notwithstanding any tolerance gap caused by a stackup dimension of the magnets and the top plate between the slotted cups.

11. The electromagnetic transducer of claim 10 wherein each slotted cup includes a first plurality of cylinder segments having the inner feature and a second plurality of cylinder segments having the outer feature.

12. The electromagnetic transducer of claim 1 wherein the top plate assembly comprises
an inner cup; and
a top plate magnetically coupled to a top of the inner cup.

13. The electromagnetic transducer of claim 1, wherein the top plate assembly is in form of a solid top plate.

14. The electromagnetic transducer of claim 2, wherein the diaphragm and the upper suspension component are of monolithic construction.

15. The electromagnetic transducer of claim 2, wherein the diaphragm and the upper suspension component are separate components coupled together.

16. The electromagnetic transducer of claim 2, wherein it further comprises lead wires coupled to the voice coil and extending out through one or more of the slots and extend over the lower suspension component to one or more electrical connectors which are coupled to the frame so as to provide electrical connection to the voice coil.

17. The electromagnetic transducer of claim 1, wherein the first cap portion, the second cap portion, the first magnet, the second magnet and the top plate assembly are formed to have an axial vent extending therethrough.

18. The electromagnetic transducer of claim 1, wherein the first magnet and the second magnet are each in form of a hybrid magnet which comprises a neodymium-ferrite-boron magnet and a ferrite magnet.

19. The electromagnetic transducer of claim 1 configured as an audio speaker.
